(19) United States
(12) Patent Application Publication
(10) Pub. No.: US 2013/0043186 A1
(43) Pub. Date: Feb. 21, 2013

(54) METHOD FOR SEPARATING LIQUID MIXTURE, AND DEVICE FOR SEPARATING LIQUID MIXTURE

(71) Applicants: Kiyoshi Araki, Nagoya-city (JP); Masaaki Kawai, Nishikasugai-county (JP); Shigeharu Hashimoto, Okazaki-city (JP)

(72) Inventors: Kiyoshi Araki, Nagoya-city (JP); Masaaki Kawai, Nishikasugai-county (JP); Shigeharu Hashimoto, Okazaki-city (JP)

(73) Assignee: NGK Insulators, Ltd., Nagoya-City (JP)

(21) Appl. No.: 13/634,379

(22) PCT Filed: Nov. 6, 2009
(86) PCT No.: PCT/JP09/69001

§ 371 Date: Oct. 31, 2012

(30) Foreign Application Priority Data
Dec. 19, 2008 (JP) 2008-323553

(51) Int. Cl. B01D 63/00

(52) U.S. Cl. 210/634; 210/500.21

(57) ABSTRACT

There are disclosed a method for separating a liquid mixture in which a permeation performance enhances, and a composition of the liquid mixture containing a hydrocarbon liquid and an alcohol liquid at supply and a composition after membrane permeation are changed by a separating operation, and a device for separating a liquid mixture. The liquid mixture containing the hydrocarbon liquid and the alcohol liquid is used as a supply mixture liquid, and at least part of the supply mixture liquid is, in a liquid state, brought into contact with a membrane supply side of a separation membrane, and discharged in a vapor state through a membrane permeation side of the separation membrane, whereby a composition of a mixture vapor which is balanced with the supply mixture liquid becomes different from a composition of a vapor on the membrane permeation side.

### TECHNICAL FIELD

The present invention relates to a method for separating a liquid mixture, in which a composition of the liquid mixture containing a hydrocarbon liquid and an alcohol liquid is changed, and a device for separating a liquid mixture.

### BACKGROUND ART

A membrane separation technology has been utilized in various fields including food and chemical fields and a water treatment field from the viewpoints of energy saving and low environmental load. In the conventional membrane separation technology, solid/liquid separation has frequently been performed as in, for example, the food field. In recent years, however, the membrane separation technology has been applied to the manufacturing of ethanol by use of a biomass. That is, as typified by the membrane separation of water and ethanol, an operation of separating, from a liquid mixture, a liquid which is rich in a specific component (e.g., water or alcohol in this case) has been performed by using the membrane separation technology, to change a composition of the liquid mixture.

As to the separating operation of the liquid mixture by use of the membrane separation technology, the aqueous system has mainly been developed as described above, but in recent years, the application of the technology to a nonaqueous system such as a petroleum refining process or a petrochemical industry field has been investigated (e.g., Patent Documents 1 to 3). For example, in Patent Document 2, there is disclosed a separation membrane for use in changing a composition of a liquid mixture containing a paraffin hydrocarbon liquid and an olefin hydrocarbon liquid by the separating operation.

As to the membrane separation technology, in addition to the above application to the separation of the mixture of the hydrocarbon liquids, there has recently been disclosed an attempt to apply the technology to the separation of a liquid mixture containing a hydrocarbon liquid and an alcohol liquid especially for the enhancement of startability of an internal combustion engine or high-efficiency burning and cleaning in a fuel field (e.g., Patent Documents 4 to 6).

In Patent Document 4, there is disclosed a method in which an alcohol mixed gasoline fuel (the liquid) is pressurized on a supply side and the pressure of the liquid is decreased by a pressure decreasing pump on a permeation side, to change a composition of a liquid mixture containing a hydrocarbon liquid and an alcohol liquid at the supply thereof and a composition of the liquid mixture after membrane permeation by a separating operation.

In Patent Document 5, there is disclosed a method in which a mixture fuel obtained by adding an ethanol fuel to a hydrocarbon fuel is preheated to supply the fuel as a vapor, and a pressure on a permeation side is decreased to 10⁻¹ mmHg or lower by a vacuum pump, to change a composition of a liquid mixture containing a hydrocarbon liquid and an alcohol liquid at the supply thereof and a composition after the membrane permeation by a separating operation.

Meanwhile, it is broadly known that when the liquid mixture containing the hydrocarbon liquid and the alcohol liquid is used as the fuel, a vapor concentration of the alcohol liquid in a balanced vapor is much higher than that of the alcohol liquid in the liquid mixture, owing to a difference in boiling point between the liquids, or the like.

Moreover, it is also well known that especially when the liquid mixture is used as the fuel for a car or the like, alcohols increase corrosion on a constituent material of a fuel tank manufactured for a hydrocarbon liquid fuel, a fuel supply device, or an internal combustion engine, especially on, for example, a metal such as aluminum or copper, a rubber, or a plastic material.

The present inventors have found the problem that a liquid supply system is remarkably corroded in the method disclosed in Patent Document 5, as a result of intensive investigation. This is supposedly because the liquid mixture containing the hydrocarbon liquid and the alcohol liquid is vaporized and supplied, and it has rationally been supposed that the alcohols in a vapor state more remarkably increase the corrosion than in a liquid state. Moreover, in the method, a lot of energy is required for preheating and vaporizing the supply liquid, which is unfavorable in respect of cost.

Furthermore, in the method disclosed in Patent Document 4, the problem of the corrosion in the liquid supply system is not recognized, but the present inventors have found that the liquid does not sufficiently permeate the permeation side as it is and that a permeation performance, especially a sufficient permeation flux (the permeation liquid amount) cannot be obtained.

### PRIOR ART DOCUMENTS

### Patent Documents

Patent Document 1: JP-A-H10-180046
Patent Document 2: JP-A-H10-180057
Patent Document 3: JP-A-2000-157843
Patent Document 4: JP-A-2008-106623
Patent Document 5: JP-A-2007-255226
Patent Document 6: JP-T-2008-536043

An object of the present invention is to provide a method for separating a liquid mixture, in which a composition of the liquid mixture containing a hydrocarbon liquid and an alcohol liquid at the supply thereof and a composition after membrane permeation are changed by a separating operation, so that corrosion due to alcohols is suppressed and a permeation performance enhances, and to provide a device for separating a liquid mixture.

### SUMMARY OF THE INVENTION

To solve the above problems, the present inventors have found that when a liquid mixture as a supply mixture liquid is, in a liquid state, brought into contact with a membrane supply side of a separation membrane, and discharged in a vapor state through a membrane permeation side of the separation membrane, whereby a composition of a mixture vapor which is balanced with the supply mixture liquid can be different from a composition of a vapor on the membrane permeation side. That is, according to the present invention, there are provided the following method for separating a liquid mixture, and the following device for separating a liquid mixture.

[1] A method for separating a liquid mixture, in which the liquid mixture containing a hydrocarbon liquid and an alcohol liquid is used as a supply mixture liquid, and at least part of the supply mixture liquid is, in a liquid state, brought into contact with a membrane supply side of a separation membrane, and discharged in a vapor state through a membrane permeation side of the separation membrane, whereby a composition of a mixture vapor which is balanced with the supply mixture liquid becomes different from a composition of a vapor on the membrane permeation side.

[2] The method for separating the liquid mixture according to the above [1], wherein a weight fraction of alcohols in the mixture vapor discharged in the vapor state on the membrane permeation side is larger than a weight fraction of alcohols in the mixture vapor which is balanced with the supply mixture liquid.

[3] The method for separating the liquid mixture according to the above [1] or [2], wherein an absolute pressure on the membrane permeation side is 450 torr or lower.

[4] The method for separating the liquid mixture according to any one of the above [1] to [3], wherein the supply mixture liquid is controlled at 50° C. or higher and at a temperature lower than a temperature at which all the supply mixture liquid evaporates.

[5] The method for separating the liquid mixture according to any one of the above [1] to [4], wherein a pressure of the supply mixture liquid is raised by pressurizing, to increase a membrane permeation amount.

[6] The method for separating the liquid mixture according to the above [5], wherein a pressure for the pressurizing is controlled to an absolute pressure of 1 atm or higher and 100 atm or lower.

[7] A device for separating a liquid mixture, which separates the liquid mixture containing a hydrocarbon liquid and an alcohol liquid, comprising: a separating section provided with a separation membrane which allows permeation of the liquid mixture containing the hydrocarbon liquid and the alcohol liquid, so that a composition of the liquid mixture is changeable, and including a porous base material which supports this separation membrane, to partition a raw material side space and a permeation side space by the porous base material; a supply section which supplies the liquid mixture to the raw material side space; and a permeation recovering section to recover, from the permeation side space, a permeation gas which has permeated the separation membrane for the liquid mixture.

[8] The device for separating the liquid mixture according to the above [7], wherein the permeation recovering section includes a cooling unit which cools and liquefies the permeation gas.

[9] The device for separating the liquid mixture according to the above [7] or [8], further comprising: a supply liquid heating unit which heats the liquid mixture as the supply mixture liquid to be supplied to the separating section.

[10] The device for separating the liquid mixture according to any one of the above [7] to [9], further comprising: a pressure raising unit which raises a pressure of the liquid mixture as the supply mixture liquid to be supplied to the separating section.

According to the method for separating the liquid mixture and the device for separating the liquid mixture of the present invention, components of the liquid mixture containing the hydrocarbon liquid and the alcohol liquid can be changed. The corrosion of a liquid supply system by the alcohols can be suppressed, and it is possible to enhance a permeation performance and especially to increase a permeation flux.

### BRIEF DESCRIPTION OF THE DRAWINGS

FIG. 1 is a view showing one embodiment of a separation membrane member provided with a separation membrane for a liquid mixture;

FIG. 2 is a sectional view in the vicinity of an end surface and an outer peripheral surface of a porous base material before disposing the separation membrane;

FIG. 3 is a sectional view in the vicinity of the end surface and the outer peripheral surface of the porous base material in which the separation membrane is disposed;

FIG. 4 is a sectional view showing a module including the porous base material in which the separation membrane is disposed; and

FIG. 5 is a schematic view showing one embodiment of a device for separating a liquid mixture of the present invention.

### MODE FOR CARRYING OUT THE INVENTION

Hereinafter, an embodiment of the present invention will be described with reference to the drawings. The present invention is not limited to the following embodiment, and change, modification and improvement can be added to the invention without departing from the scope thereof.

A method for separating a liquid mixture of the present invention is a method in which the liquid mixture containing a hydrocarbon liquid and an alcohol liquid is used as a supply mixture liquid, and at least part of the supply mixture liquid is, in a liquid state, brought into contact with a membrane supply side of a separation membrane, and discharged in a vapor state through a membrane permeation side of the separation membrane, whereby a composition of a mixture vapor which is balanced with the supply mixture liquid becomes different from a composition of a vapor on the membrane permeation side.

A separation membrane (the separation membrane for the liquid mixture) 11 for use in the separating method of the present invention is such a separation membrane that the liquid mixture containing the hydrocarbon liquid and the alcohol liquid is used as the supply mixture liquid, and at least part of the supply mixture liquid is, in the liquid state, brought into contact with the membrane supply side of the separation membrane, and discharged in the vapor state through the membrane permeation side of the separation membrane, whereby the composition of the mixture vapor which is balanced with the supply mixture liquid can become different from the composition of the vapor on the membrane permeation side. More specifically, the separation membrane is a porous separation membrane disposed on the surface of a porous base material 1. Any material, pore structure, fine structure or the like of the separation membrane may be used, as long as the separation membrane has the above function, but suitable examples of the separation membrane can include a polymer or ceramic separation membrane, i.e., a zeolite membrane (the MFI type or the like), a mesoporous silica membrane, and a carbon membrane.

The method for separating the liquid mixture of the present invention is a method in which the composition of the liquid mixture is changed by using the separation membrane 11. The liquid mixture which can be used in the separating method of the present invention contains the hydrocarbon liquid and the alcohol liquid. The hydrocarbon liquid can be classified into a paraffin liquid, an olefin liquid, a naphthene liquid, an aromatic liquid and the like, but examples of the hydrocarbon liquid can include n-pentane, n-hexane, n-heptane, n-octane, n-dodecane, 2-methylbutane, 1-pentene, 1-hexene, 1-octene, cyclopentane, cyclohexane, benzene, toluene, o-xylene, m-xylene, and p-xylene. Moreover, examples of the alcohol liquid can include methanol, ethanol, 1-propanol, 2-propanol, n-butanol, and 2-butanol.

The method for separating the liquid mixture of the present invention includes a step of bringing at least part of a supply liquid mixture in the liquid state into contact with the membrane supply side of the separation membrane 11, and discharging the part in the vapor state through the membrane permeation side of the separation membrane. This is a so-called pervaporation process, and the liquid is preferably supplied in a heated state so as to increase a permeation flux. To obtain the sufficient permeation flux, heating at 50° C. or higher is preferable. Moreover, as long as the corrosion of a supply system by the vapor of the alcohol liquid can be suppressed, the heating temperature may be further higher, and may be lower than a temperature at which all the supply mixture liquid evaporates.

The supply mixture liquid is discharged in the vapor state through the membrane permeation side, but for this purpose, it is necessary to decrease a pressure on the membrane permeation side by use of a vacuum unit such as a known vacuum pump. A vacuum degree is preferably lower, and is 50 torr or lower, and more preferably 10 torr or lower in an absolute pressure. However, when energy consumption to obtain the vacuum degree is taken into consideration, such a high vacuum is not necessarily required, and the vacuum degree may be 450 torr or lower in the absolute pressure.

On the liquid supply system, pressurizing control may be performed to increase the permeation flux. For the pressurizing, a known method for use in a fuel supply device of an internal combustion engine can be used. That is, a fuel pump, a pressure regulator, a common rail or the like can be exemplified. A pressure of the pressurizing is preferably higher, but is preferably 100 atm or lower, when the energy consumption and the cost of a pressurizing unit are taken into consideration.

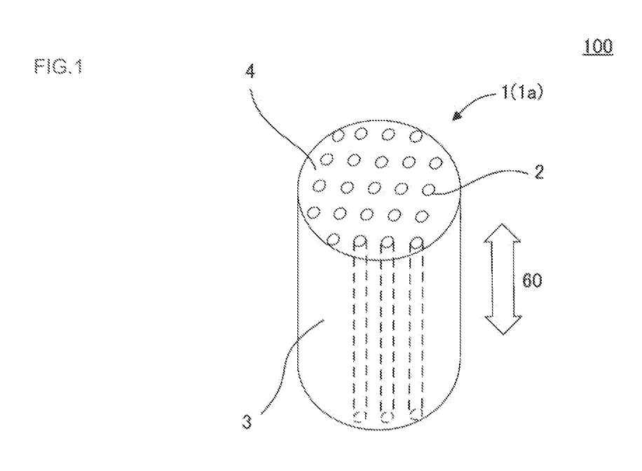

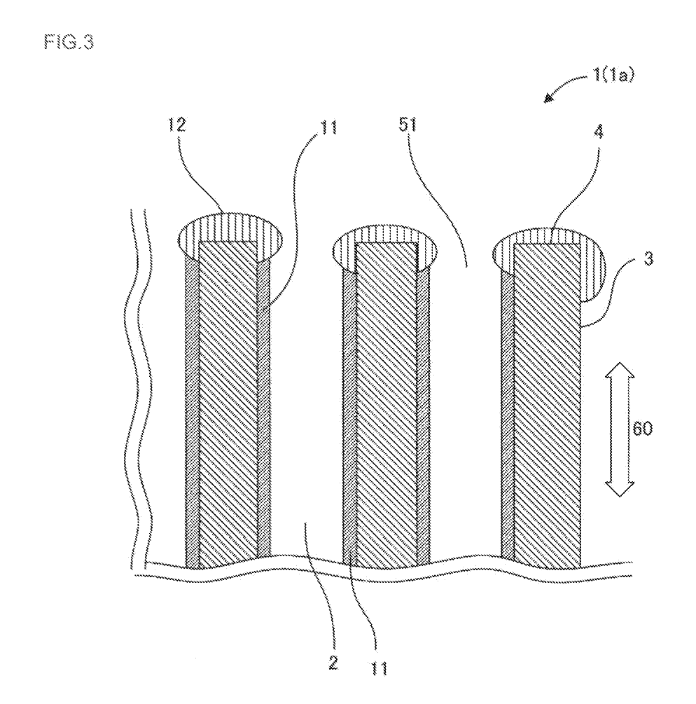

FIG. 1 shows one embodiment of a separation membrane member 100 provided with the separation membrane 11 of the present invention. The separation membrane 11 is formed on an inner wall surface 5 of each of through pores 2 formed along a longitudinal direction 60 of the porous base material 1 having a monolith shape, and seal portions 12 are disposed on both end surfaces 4 and 4 (see FIG. 3). The seal portions 12 are entirely disposed on both the end surfaces 4 and 4 of the porous base material 1 (a monolith shape base material 1a) so that the through pores 2 are not closed.

In the separation membrane member 100, the liquid mixture flows into the through pores 2 through openings 51 of the through pores 2 of the monolith shape base material 1a, and part of the liquid mixture (the passing fluid) permeates the separation membrane 11 disposed on the inner wall surface 5 of the through pore 2 to flow into the monolith shape base material 1a, and is discharged to the outside through a side surface 3 of the monolith shape base material 1a, to separate the liquid mixture. The seal portions 12 prevent the liquid mixture from flowing into the monolith shape base material through the end surfaces 4 of the monolith shape base material 1a, and prevents the passing fluid passing through the separation membrane 11 and the liquid mixture flowing into the base material through the end surfaces 4 from being mixed and discharged through the side surface 3.

In the separation membrane 11 of the present invention, there is not any special restriction on a material, a pore structure, a fine structure or the like of the separation membrane as described above, but a polymer or ceramic separation membrane, i.e., a zeolite membrane (the MFI type or the like), a mesoporous silica membrane, or a carbon membrane can be exemplified as a suitable example. In particular, the membrane is preferably the carbon membrane obtained by thermally decomposing and carbonizing a carbon containing layer as a precursor in an oxygen inactive atmosphere. Moreover, the thermal decomposition is preferably performed at 400 to 1000° C., and further preferably performed at 450 to 900° C. The oxygen inactive atmosphere is an atmosphere where the precursor to form the carbon membrane is not oxidized even when heated in the above temperature range, and is specifically an atmosphere of an inactive gas such as nitrogen or argon, a vacuum or the like.

There is not any special restriction on the precursor to form the carbon membrane by the thermal decomposition, as long as carbon is contained, but examples of the precursor can include polyethylene glycol, ethyl cellulose and another resin. As the resin, it is possible to suitably use a resin including, as a main component, a polyimide resin, a phenolic resin, a polyamide-imide resin or the like. Here, the main component is a component contained as much as 50 mass % or more in the whole resin.

A thickness of the carbon membrane is preferably from 0.05 to 5.0 μm, and further preferably from 0.05 to 1.0 μm. When the thickness is smaller than 0.05 μm, a defect is generated in the carbon membrane sometimes, and when the thickness is larger than 5.0 μm, the permeation flux in the separation of the mixture decreases sometimes. An average pore diameter of the carbon membrane is preferably from 0.2 to 100 nm, and further preferably from 0.2 to 10 nm. The average pore diameter can be measured by a gas adsorption process.

In the separation membrane member 100 of the present embodiment, any material of the porous base material 1 may be used as long as a strength, a permeation performance, a corrosion resistance or the like is sufficient, a metal or a ceramic can be used, and there is not any special restriction on the material. However, preferably on a base material which is an alumina porous base material of a monolith shape having an average particle diameter of 10 to 100 μm and an average pore diameter of 1 to 30 μm, alumina particles having an average particle diameter of 0.3 to 10 μm are deposited by filter membrane formation, and fired, to form a first surface dense layer having a thickness of 10 to 1000 μm and an average pore diameter of 0.1 to 3 μm. Further on the first surface dense layer, alumina particles having an average particle diameter of 0.03 to 1 μm are further deposited by the filter membrane formation, and fired, to preferably form a second surface dense layer having a thickness of 1 to 100 μm and an average pore diameter of 0.01 to 0.5 μm. Moreover, a porosity is preferably from 20 to 80%, and further preferably from 30 to 70%. As particles constituting the porous base material 1, ceramic particles are preferable, and specifically, alumina particles, silica particles, cordierite particles, zirconia particles, mullite particles or the like are preferable.

There is not any special restriction on the shape of the porous base material 1, and the shape can be determined from a disc shape, a polygonal plate-like shape, a tubular shape such as a cylindrical shape or a square tubular shape, a post-like shape such as a columnar shape or a square post shape, or the like, in accordance with the purpose. Moreover, there is not any special restriction on a size of the porous base material, and the size can be determined, in accordance with the purpose, in such a range that a strength required for a support member is satisfied and that a permeability of a fluid to be separated is not impaired. A ratio of a membrane area to a volume is large, a pressure of the supply mixture liquid is raised to about 100 atm sometimes as described later, and also from the viewpoint of a pressure resistance, the monolith shape is especially preferable. “The monolith shape base material” is a lotus root-like or honeycomb-like base material in which a plurality of through pores are formed in the longitudinal direction 60.

Examples of the seal portion 12 can include a glass seal and a metal seal, and in these seals, the glass seal is preferable because the seal is excellent in that a thermal expansion coefficient of the seal can easily be adjusted to that of the porous base material. There is not any special restriction on physical properties of glass for use in the glass seal, but the glass preferably has a thermal expansion coefficient which is close to the thermal expansion coefficient of the porous base material. Moreover, as the glass for use in the glass seal, nonlead glass which does not contain any lead is preferable.

Next, a manufacturing method of the separation membrane 11 for the liquid mixture will be described. In advance, the porous base material 1 which is a base material to form the separation membrane 11 is manufactured by extrusion forming and firing of a manufacturing method of the conventional porous monolith shape base material 1a.

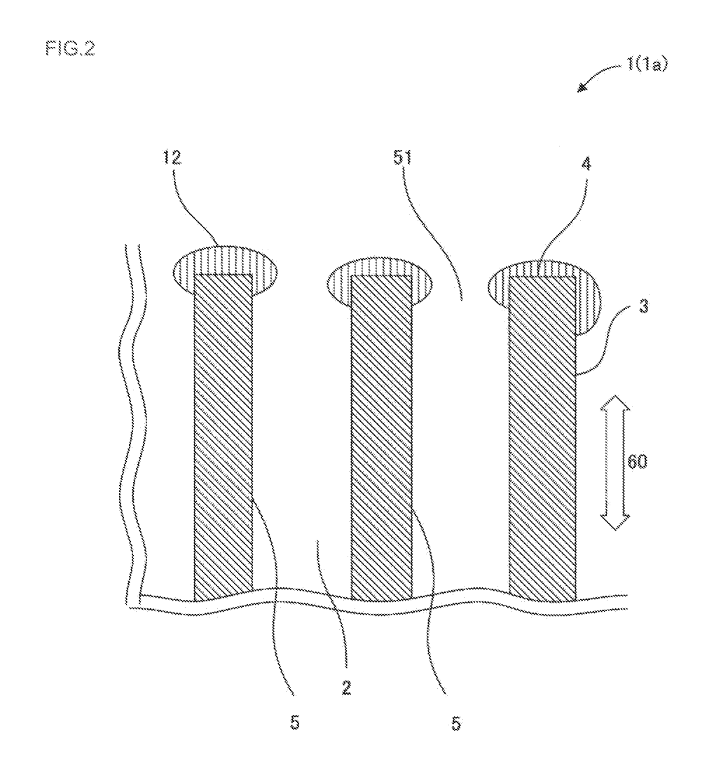

Next, both the end surfaces 4 and 4 of the porous base material 1 are coated with a glass paste, and heated at a predetermined temperature, to form the seal portions 12 as shown in FIG. 2. First, the surface of the porous base material 1 is coated with the glass paste. There is not any special restriction on a portion to be coated with the glass paste, and it is preferable to coat a portion of the surface of the porous base material 1 in which a gas, a liquid, fine particles and the like are prevented from moving to the outside from the porous base material 1 or moving from the outside into the porous base material 1. In the present embodiment, both the end surfaces 4 and 4 of the porous base material 1 (the monolith shape base material 1a) are coated with the glass paste.

As a glass material of the glass paste to coat the surface of the porous base material 1, the nonlead glass which does not contain any lead is preferable. Moreover, the glass material has a softening point of preferably 600 to 1000° C. and further preferably 700 to 1000° C. When the softening point is lower than 600° C., the glass melts sometimes at heating in a forming step of the separation membrane 11, and when the softening point is higher than 1000° C., the sintering of particles constituting the porous base material 1 proceeds more than necessary sometimes. The glass paste can be prepared by dispersing powder-like glass in a solvent such as water. Moreover, the glass paste may be prepared by adding polymers or the like to a solvent such as the water.

Next, there is performed a membrane forming step of forming a membrane made of a precursor solution to form the separation membrane 11 on the porous base material 1. In the membrane forming step, there is not any special restriction on a method of passing the precursor solution through the through pores 2 of the monolith shape base material 1a, as long as a membrane thickness becomes even, but suitable examples of the method can include a dip membrane forming method.

As the precursor solution to form the separation membrane for use in the membrane formation of the membrane forming step in the one embodiment of the present invention, a polyimide solution and/or a phenol solution is preferably used. The polyimide solution and/or the phenol solution is obtained by dissolving a polyimide resin and/or the phenol solution in a suitable organic solvent of N-methyl-2-pyrrolidone (NMP) or the like. There is not any special restriction on a concentration of polyimide and/or the phenol solution in the polyimide solution and/or the phenol solution, but the concentration is preferably from 1 to 15 mass % from the viewpoint that a viscosity of the solution is set so as to facilitate the membrane formation.

Next, a drying step is performed to dry a membrane (the coat layer) made of the precursor solution. In the drying step, for example, the blow drying of the membrane made of the precursor solution is performed while passing hot air from an opening 51 of the one end surface 4 to an opening 51 of the other end surface 4.

After the drying step, the polyimide membrane and/or the phenol membrane is subjected to a heating treatment step (the carbonization) in vacuum or in an inactive atmosphere such as a nitrogen atmosphere or an argon atmosphere. The thermal decomposition is performed in a temperature range of about 400 to 1000° C. to perform the carbonization, whereby the separation membrane 11 (the carbon membrane) is formed as shown in FIG. 3. That is, the separation membrane 11 is obtained by thermally decomposing and carbonizing a resin layer as a precursor in an oxygen inactive atmosphere. In general, when the carbonization is performed at a temperature which is lower than 400° C., the polyimide membrane and/or the phenol membrane is not sufficiently carbonized, and a selectivity or a permeation speed of a molecular sieve membrane deteriorates. On the other hand, when the carbonization is performed at a temperature in excess of 1000° C., pore diameters contract, and accordingly a permeation speed decreases.

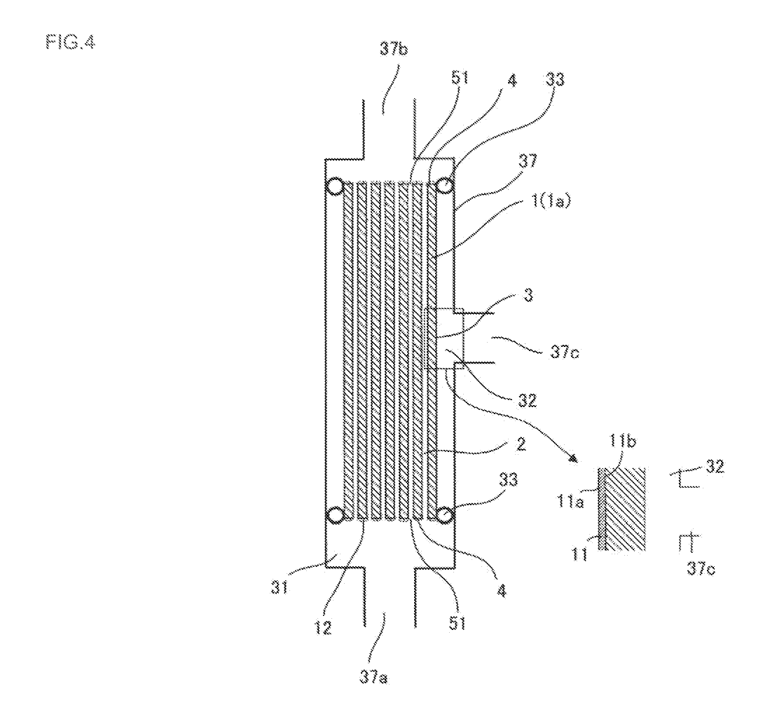

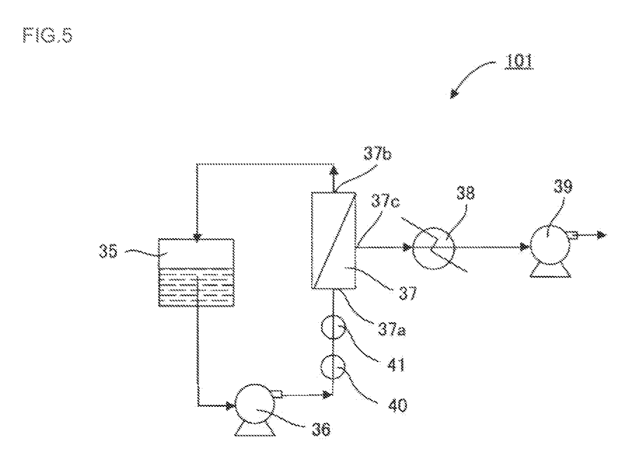

The method for separating the liquid mixture of the present invention can be performed by using, specifically, a mixture separating device 101 shown in FIG. 4 and FIG. 5. That is, the liquid mixture separating device 101 of the present invention includes a separating section which partitions a raw material side space and a permeation side space, a supply section which supplies the liquid mixture to the raw material side space, and a permeation recovering section to recover, from the permeation side space, a permeation gas which has permeated the separation membrane for the liquid mixture. The separating section is constituted of a module 37 which is provided with the separation membrane 11 for the liquid mixture and includes the porous base material 1 which supports this separation membrane. Any material of a casing portion of the module 37 may be used, but from the viewpoint of the cost, an inexpensive plastic material is preferable, and for weight saving, aluminum or the like is preferable. Moreover, the supply section is constituted of a raw material tank 35 and a circulating pump 36, and the permeation recovering section is constituted of a cooling trap 38 and a vacuum pump 39.

The raw material tank 35 heats and holds the liquid mixture (the raw material) containing the hydrocarbon liquid and the alcohol liquid and placed into the tank, at a predetermined temperature (e.g., 50° C.).

In the module 37, a supply liquid introduction port 37a and a supply liquid discharge port 37b are formed so as to communicate with a raw material side space 31, and a permeation vapor recovery port 37c, through which a permeation vapor is discharged to the outside, is formed so as to communicate with a permeation side space 32. The liquid mixture in the raw material tank 35 is supplied to the raw material side space 31 of the module 37 by the circulating pump 36.

The module 37 has a constitution where the monolith shape base material 1a provided with the carbon membrane can be disposed at a predetermined position via o-rings 33 arranged in both end outer peripheral portions of the base material. The module 37 is partitioned into the raw material side space 31 and the permeation side space 32 by the o-rings 33, the glass seals (the seal portions 12) and the separation membrane 11.

On the permeation vapor recovery port 37c side of the module 37, the cooling trap 38 which is a cooling unit and the vacuum pump 39 are arranged, and the permeation vapor discharged through the permeation vapor recovery port 37c is recovered by a liquid N₂ trap.

The liquid mixture separating device 101 includes a supply liquid heating unit 40 which heats the liquid mixture as the supply mixture liquid to be supplied to the separating section, and the liquid is preferably supplied in a heated state. The supply liquid heating unit 40 can be disposed in a stage which is previous to the module 37, but may be disposed so as to heat the whole module 37, whereby the supply liquid may indirectly be heated. Moreover, the supply liquid heating unit may be integrated with the module 37, so that the module 37 itself may also serve as the supply liquid heating unit 40. Furthermore, the liquid mixture separating device 101 includes a pressure raising unit 41 which raises the pressure of the liquid mixture as the supply mixture liquid to be supplied to the separating section, and the pressurizing is preferably controlled so as to increase the permeation flux. The pressurizing can be performed by using a known method for use in the fuel supply device of the internal combustion engine. That is, the pressure raising unit 41 preferably includes a fuel pump, a pressure regulator, a common rail and the like.

According to the above constitution, a raw material is supplied to the raw material side space 31 of the module 37 through the supply liquid introduction port 37a by the circulating pump 36, and the raw material discharged through the supply liquid discharge port 37b is returned to the raw material tank 35 to circulate the raw material. In the method for separating the liquid mixture of the present invention, the above-mentioned liquid mixture is used as the raw material. This liquid mixture is supplied as the supply mixture liquid through the supply introduction port 37a, and at least part of the supply mixture liquid is, in a liquid state, brought into contact with a membrane supply side 11a of the separation membrane. The pressure on a supporter side of the separation membrane 11 is decreased by the vacuum pump 39, whereby the permeation vapor which has permeated a membrane permeation side 11b of the separation membrane 11 and is discharged through the permeation vapor recovery port 37c is recovered by the liquid N₂ trap. The vacuum degree of the permeation side space 32 is controlled at a predetermined low pressure (e.g., about 0.5 Torr) by a pressure controller. In consequence, the composition of the mixture vapor which is balanced with the supply mixture liquid becomes different from the composition of the vapor on the membrane permeation side.

Specifically, a weight fraction of alcohols in the mixture vapor discharged in the vapor state on the membrane permeation side is preferably larger than a weight fraction of alcohols in the mixture vapor which is balanced with the supply mixture liquid. Moreover, the pressure on the membrane permeation side is preferably 450 torr or lower in the absolute pressure. Furthermore, the supply mixture liquid is preferably controlled at 50° C. or higher and at a temperature lower than a temperature at which all the supply mixture liquid evaporates.

The pressure of the supply mixture liquid is preferably raised by the pressurizing, to increase a membrane permeation amount, and the pressure for the pressurizing is further preferably controlled to an absolute pressure of 1 atm or higher and 100 atm or lower.

### EXAMPLES

Hereinafter, the present invention will be described in more detail with respect to examples, but the present invention is not limited to these examples.

### Example

### Preparation of Porous Base Material

A columnar base material (the monolith shape base material 1a) of porous alumina was prepared by extrusion forming and firing, and the base material was provided with 55 through linear pores (the through pores 2) each having a diameter of 2.5 mm and formed along the longitudinal direction 60, and had a diameter of 30 mm and a length of 160 mm. Furthermore, seals (the seal portions 12) were disposed on both the end portions 4 and 4 of the monolith shape base material 1a by melting glass, and the base material was used later in a test (see FIG. 2).

<Preparation of Carbon Membrane>

The inner surfaces of the through linear pores 2 of the monolith shape base material 1a were dip-coated with a solution obtained by dissolving a commercially available polyimide resin (U Varnish S manufactured by Ube Industries Ltd.) in a solvent, to form a coat layer. Hot air was blown through the through linear pores 2 to roughly dry the solvent, and then the base material was dried at 300° C. in the atmosphere for one hour by a drier. This step was repeated four times, to form a resin layer on the inner surfaces of the through linear pores 2 of the monolith shape base material 1a. When the one end surface 4 of the monolith shape base material 1a was closed and the base material was evacuated through the opposite end surface 4 by a commercially available rotating vacuum pump to check whether or not the formed resin layer coated all the inner surfaces of the through linear pores, it was confirmed that the pressure reached 100 Pa or lower. When the monolith shape base material 1a provided with the resin layer was thermally treated in a nitrogen atmosphere at 600° C. for one hour (a pressure raising speed of 300° C./h) to carbonize the resin layer, a carbon membrane (the separation membrane 11) formed on the inner surfaces of the through pores 2 of the monolith shape base material 1a was obtained. When a carbon content of the carbon membrane was measured by a fully automatic element analysis device, the carbon content was 70% or larger. Moreover, a membrane thickness of the carbon membrane was about 0.5 micron according to the observation of a cross section with SEM.

<Liquid Mixture Separation Test>

A liquid mixture separation test by permeation evaporation (the pervaporation) was performed by using a device shown in FIG. 5 (the mixture separating device 101). A liquid mixture containing a hydrocarbon liquid and an alcohol liquid and placed into the raw material tank 35 (and having a sufficient volume for a device system) was heated and held at a predetermined temperature (e.g., 50° C.). There was disposed, at a predetermined position, a casing (made of an aluminum alloy) in which the monolith shape base material 1a provided with the carbon membrane as described above was contained via the o-rings 33 arranged in the outer peripheral portions of both ends (the module 37).

The raw material (the liquid mixture) was supplied to the raw material side space 31 of the module 37 through the supply liquid introduction port 37a by the circulating pump 36, and the raw material discharged through the supply liquid discharge port 37b was returned to the raw material tank 35 to circulate the raw material. A linear speed during the circulation was 1.4 m per second. A pressure on the supporter side of the separation membrane 11 was decreased by the vacuum pump 39, whereby a permeation vapor which had permeated the separation membrane 11 and was discharged through the permeation vapor recovery port 37c was recovered by a liquid N₂ trap. A vacuum degree of the permeation side space 32 was controlled at a predetermined low pressure (e.g., about 0.5 Torr) by a pressure controller. All recovery amounts were averaged for 30 minutes after a base point which was 30 minutes after the start of the test, to calculate an initial permeation flux.

In the device, the liquid mixture separation test was performed, a liquefied substance of the permeation vapor recovered by a liquid nitrogen trap was subjected to gas chromatography analysis, and a composition of the permeation vapor was quantified. An initial vapor composition was measured similarly to the permeation flux. A performance evaluation of the separating device was carried out as above.

### Example 1

As a hydrocarbon liquid, o-xylene (the reagent) was selected, as an alcohol liquid, ethanol (the reagent) was selected, and a mixture containing 50 mass % of each of the liquids was used as a supply liquid (the raw material or the liquid mixture). Control was executed so that a supply liquid temperature (=the temperature of the whole system can be assumed) was 50° C., and a vacuum degree of a permeation side space was 0.5 torr. In consequence, an initial composition of a permeation side vapor included 3 mass % of o-xylene and 97 mass % of ethanol. Moreover, an initial permeation vapor flux in this case (a permeation vapor amount per unit membrane area and per unit time) was 0.5 kg/m²h. It became clear from a preliminary test that an ethanol fraction of a vapor which was balanced with the supply liquid was about 92 mass %, and hence separation in excess of gas-liquid equilibrium was realized. Any corrosion was not recognized on o-rings and a casing.

### Example 2

A test similar to that of Example 1 was performed, except that a test evaluation device was changed to the device of pressure test specifications (a casing was also changed to a stainless steel) and a pressure of a supply liquid was raised to a gauge pressure of 100 atm. In consequence, an initial composition of a permeation side vapor included 3 mass % of o-xylene and 97 mass % of ethanol. Moreover, an initial permeation vapor flux in this case was 0.8 kg/m²h. It became clear from a preliminary test that an ethanol fraction of a vapor which was balanced with the supply liquid at an ordinary pressure was about 92 mass %, and hence separation in excess of gas-liquid equilibrium was realized. Any corrosion was not recognized on o-rings and a casing.

### Example 3

A test similar to that of Example 1 was performed, except that as a hydrocarbon liquid, o-xylene (the reagent) was selected, as an alcohol liquid, n-butanol (the reagent) was selected, and a mixture containing 50 mass % of each of the liquids was used as a supply liquid. In consequence, an initial composition of a permeation side vapor included 9 mass % of o-xylene and 91 mass % of butanol. Moreover, a permeation vapor flux in this case (the permeation vapor amount) was 0.3 kg/m²h. It became clear from a preliminary test that an n-butanol fraction of a vapor which was balanced with the supply liquid was about 56 mass %, and hence separation in excess of gas-liquid equilibrium was realized. Any corrosion was not recognized on o-rings and a casing.

### Example 4

A test similar to that of Example 1 was performed, except that a temperature of a supply liquid was 70° C. In consequence, an initial composition of a permeation side vapor included 3 mass % of o-xylene and 97 mass % of ethanol. Moreover, an initial permeation flux in this case was 0.7 kg/m²h. It became clear from a preliminary test that an ethanol fraction of a vapor which was balanced with the supply liquid was about 75 mass %, and hence separation in excess of gas-liquid equilibrium was realized. Any corrosion was not recognized on o-rings and a casing.

### Example 5

As hydrocarbon liquids, n-octane (the reagent) and o-xylene (the reagent) were selected, as an alcohol liquid, ethanol (the reagent) was selected, and a mixture containing 33.3 mass % of each of the liquids was used as a supply liquid. Control was executed so that a supply liquid temperature (=the temperature of the whole system can be assumed) was 50° C., and a vacuum degree of a permeation side space was 0.5 torr. In consequence, an initial composition of a permeation side vapor included 2 mass % of n-octane, 5 mass % of o-xylene and 93 mass % of ethanol. Moreover, an initial permeation vapor flux in this case was 0.4 kg/m²h. It became clear from a preliminary test that an ethanol fraction of a vapor which was balanced with the supply liquid was about 70 mass %, and hence separation in excess of gas-liquid equilibrium was realized. Any corrosion was not recognized on o-rings and a casing.

### Example 6

A test similar to that of Example 5 was performed, except that control was executed so that a permeation side vacuum degree was 450 torr. In consequence, an initial composition of a permeation side vapor included 3 mass % of n-octane, 8 mass % of o-xylene and 89 mass % of ethanol. Moreover, an initial permeation flux in this case was 0.05 kg/m²h. It became clear from a preliminary test that an ethanol fraction of a vapor which was balanced with the supply liquid was about 70 mass %, and hence separation in excess of gas-liquid equilibrium was realized. Any corrosion was not recognized on o-rings and a casing.

### Example 7

A carbon membrane was similarly prepared, except that a thermal decomposition temperature of a resin layer was 450° C. in <the preparation of the carbon membrane>. When a carbon content of the carbon membrane was measured, the content was 50% or larger. Moreover, a membrane thickness of the carbon membrane was about 1 micron. A test similar to that of Example 1 was performed, except that the carbon membrane having a different thermal decomposition temperature in the preparation method was used. In consequence, an initial composition of a permeation side vapor included 5 mass % of o-xylene and 95 mass % of ethanol. Moreover, an initial permeation flux in this case was 0.4 kg/m²h. It became clear from a preliminary test that an ethanol fraction of a vapor which was balanced with a supply liquid was about 92 mass %, and hence separation in excess of gas-liquid equilibrium was realized. Any corrosion was not recognized on o-rings and a casing.

### Example 8

A carbon membrane was similarly prepared, except that a raw material resin was a commercially available phenolic resin (Bellpearl 5899 manufactured by Air Water Inc.), and a thermal decomposition temperature of a resin layer was 550° C. in <the preparation of the carbon membrane>. When a carbon content of the carbon membrane was measured, the content was 90% or larger. Moreover, a membrane thickness of the carbon membrane was about 0.5 micron. A test similar to that of Example 5 was performed, except that the carbon membrane containing a different type of raw material resin and having a different thermal decomposition temperature in the preparation method was used. In consequence, an initial composition of a permeation side vapor included 1 mass % of n-octane, 2 mass % of o-xylene and 97 mass % of ethanol. Moreover, an initial permeation flux in this case was 0.7 kg/m²h. It became clear from a preliminary test that an ethanol fraction of a vapor which was balanced with a supply liquid was about 70 mass %, and hence separation in excess of gas-liquid equilibrium was realized. Any corrosion was not recognized on o-rings and a casing.

### Example 9

### MFI Zeolite Membrane

An MFI zeolite membrane was obtained as follows.

(Preparation of Sol for Seeding)

31.22 g of a solution containing 40 mass % of tetrapropyl ammonium hydroxide (manufactured by SACHEM Co.) and 16.29 g of tetrapropyl ammonium bromide (manufactured by Wako Pure Chemical Industries, Ltd.) were mixed, and 71.25 g of distilled water and 82 g of about 30 mass % silica sol (trade name: Snowtex S by Nissan Chemical Industries, Ltd.) were further added and stirred at room temperature to obtain a sol for seeding.

(Generation of Zeolite Seed Crystals)

The obtained sol for seeding was placed into a 300 ml pressure resistant container made of stainless steel and including an inner cylinder of a fluororesin disposed in the container, and the above monolith shape base material having a diameter of 30 mm and a length of 160 mm was immersed into the sol, to perform a reaction at 110° C. for 12 hours. A reacted supporter was boiled, sterilized and then dried at 80° C. It was confirmed by X-ray analysis of reacted crystal particles that an MFI type zeolite was deposited and present on the inner surfaces of through linear pores of the monolith shape base material.

(Preparation of Sol for Membrane Formation)

0.80 g of a solution containing 40 mass % of tetrapropyl ammonium hydroxide (manufactured by SACHEM Co.) and 0.42 g of tetrapropyl ammonium bromide (manufactured by Wako Pure Chemical Industries, Ltd.) were mixed, and 193.26 g of distilled water and 6.3 g of about 30 mass % silica sol (trade name: Snowtex S by Nissan Chemical Industries, Ltd.) were further added and stirred with a magnetic stirrer at room temperature for 30 minutes to obtain a sol for membrane formation.

(Formation of Zeolite Membrane)

The obtained sol for membrane formation was, in the same manner as described above, placed into the 300 ml pressure resistant container made of stainless steel and including the inner cylinder of the fluororesin disposed in the container, and the above porous alumina monolith shape base material including the deposited zeolite seed crystals was immersed into the sol, to perform a reaction at 160° C. for 24 hours. The reacted supporter was boiled and sterilized five times, and then dried at 80° C. for 16 hours. For the purpose of growing the zeolite membrane, this operation (in the formation of the zeolite membrane) was repeated again. The monolith shape base material was thermally treated in the atmosphere at 500° C. for four hours, and tetrapropyl ammonium was removed, to obtain the MFI type zeolite membrane formed on the inner surfaces of the through linear pores of the monolith shape base material. A membrane thickness of the MFI zeolite membrane was about 12 microns.

As hydrocarbon liquids, n-octane (the reagent) and o-xylene (the reagent) were selected, as an alcohol liquid, ethanol (the reagent) was selected, and a mixture containing 33.3 mass % of each of the liquids was used as a supply liquid. Control was executed so that a supply liquid temperature (=the temperature of the whole system can be assumed) was 50° C., and a vacuum degree of a permeation side space was 0.5 torr. In consequence, an initial composition of a permeation side vapor included 46 mass % of n-octane, 8 mass % of o-xylene and 46 mass % of ethanol. Moreover, an initial permeation flux in this case was 0.03 kg/m²h. Any corrosion was not recognized on o-rings and a casing.

### Comparative Example 1

A test similar to that of Example 1 was performed, except that control was executed so that a permeation side vacuum degree was 600 torr. In consequence, a vapor of a measurable level did not permeate the permeation side.

### Comparative Example 2

A test similar to that of Example 5 was performed, except that control was executed so that a permeation side vacuum degree was 550 torr. In consequence, a vapor of a measurable level did not permeate the permeation side.

### Comparative Example 3

A test similar to that of Example 4 was performed, except that the test device of Example 4 was partially modified, an evaporating device for heating a supply liquid to beforehand convert all the liquid to a vapor was disposed in a previous stage of a module, and a liquid mixture was completely evaporated and supplied. In consequence, an initial composition of a permeation side vapor included 3 mass % of o-xylene and 97 mass % of ethanol. Moreover, an initial permeation flux in this case was 1.0 kg/m²h. It became clear from a preliminary test that an ethanol fraction of a vapor which was balanced with the supply liquid was about 75 mass %, and hence separation in excess of gas-liquid equilibrium was realized. However, corrosion was recognized especially on portions of o-rings and a casing which came in contact with a raw material side space, and the continuation of the test was not possible any more.

### Comparative Example 4

A test similar to that of Example 2 (100 atm) was performed, except that the test device of Example 2 was further modified and a permeation side was beforehand filled with the same liquid as a supply liquid. In consequence, there was not recognized, on the permeation side, any liquid amount change or any pressure change indicating that the supply liquid leached out. Moreover, also in the composition, any change from the pre-filled supply liquid was not recognized.

### Comparative Example 5

A test similar to that of Example 2 was performed, except that a commercially available alumina precise filter membrane (the MF membrane manufactured by NGK insulators Ltd., i.e., the porous alumina columnar filter membrane (pore diameters of 0.5 μm) including 55 through linear pores each having a diameter of 2.5 mm, and having a diameter of 30 mm and a length of 160 mm) was used, and in the device of the pressure resistant specifications used in Example 2, a pressure of a supply liquid was raised to a gauge pressure of 10 atm. In consequence, a mixture was discharged in a liquid state on a permeation side, but when a composition of the liquid was analyzed, the composition included 50 mass % of o-xylene and 50 mass % of ethanol in the same manner as in the supply liquid.

The separation membranes of the examples and the comparative examples are shown in Table 1, evaluation results thereof are summarized in Table 2 and Table 3.

TABLE 1

| | Separation | Raw material | Heating | Carbon | Membrane |
|---|---|---|---|---|---|
| | membrane | resin | treatment | content | thickness |
| Examples 1 to 6 | Carbon | Polyimide | Nitrogen | 70% or | 0.5 μm |
| Comparative | membrane | resin | atmosphere | larger | |
| Examples 1 to 4 | | | 660° C. · 1 hour | | |
| Example 7 | | Polyimide | Nitrogen | 50% or | 1 μm |
| | | resin | atmosphere | larger | |
| | | | 450° C. · 1 hour | | |
| Example 8 | | Phenolic | Nitrogen | 90% or | 0.5 μm |
| | | resin | atmosphere | larger | |
| | | | 550° C. · 1 hour | | |

| | | | |
|---|---|---|---|
| Example 9 | MFI zeolite | — | 12 μm |
| | membrane | | |
| Comparative | Alumina precise | — | — |
| Example 5 | filter membrane | | |

TABLE 2

| | Supply side | | | | |
|---|---|---|---|---|---|
| | Supply | | | | |
| | liquid | Hydrocarbon liquid | | Alcohol liquid | |
| | temp. | o-xylene | n-octane | Ethanol | n-butanol |
| | (° C.) | (mass %) | (mass %) | (mass %) | (mass %) |
| Example 1 | 50 | 50 | — | 50 | — |
| Example 2 | 50 | 50 | — | 50 | — |
| Example 3 | 50 | 50 | — | — | 50 |
| Example 4 | 70 | 50 | — | 50 | — |
| Example 5 | 50 | 33.3 | 33.3 | 33.3 | — |
| Example 6 | 50 | 33.3 | 33.3 | 33.3 | — |
| Example 7 | 50 | 50 | — | 50 | — |
| Example 8 | 50 | 33.3 | 33.3 | 33.3 | — |
| Example 9 | 50 | 33.3 | 33.3 | 33.3 | — |
| Comparative | 50 | 50 | — | 50 | — |
| Example 1 | | | | | |
| Comparative | 50 | 33.3 | 33.3 | 33.3 | — |
| Example 2 | | | | | |
| Comparative | — | 50 | — | 50 | — |
| Example 3 | | | | | |
| Comparative | 50 | 50 | — | 50 | — |
| Example 4 | | | | | |
| Comparative | 50 | 50 | — | 50 | — |
| Example 5 | | | | | |

*In Example 2, the pressurizing was performed at 100 atm.
*In Comparative Example 3, the supply liquid was heated and completely evaporated.
*In Comparative Example 4, the pressurizing was performed at 100 atm, and the permeation side was beforehand filled with the same liquid as the supply liquid.
*In Comparative Example 5, the pressure of the supply liquid was raised to 10 atm.

TABLE 3

| | Permeation side | | | | | |
|---|---|---|---|---|---|---|
| | Permeation | Hydrocarbon liquid | | Alcohol liquid | | Permeation |
| | side vacuum | o-xylene | n-octane | Ethanol | n-butanol | vapor flux |
| | degree (torr) | (mass %) | (mass %) | (mass %) | (mass %) | (kg/m²h) |
| Example 1 | 0.5 | 3 | — | 97 | — | 0.5 |
| Example 2 | 0.5 | 3 | — | 97 | — | 0.8 |
| Example 3 | 0.5 | 9 | — | — | 91 | 0.3 |
| Example 4 | 0.5 | 3 | — | 97 | — | 0.7 |
| Example 5 | 0.5 | 5 | 2 | 93 | — | 0.4 |
| Example 6 | 450 | 8 | 3 | 89 | — | 0.05 |
| Example 7 | 0.5 | 5 | — | 95 | — | 0.4 |
| Example 8 | 0.5 | 2 | 1 | 97 | — | 0.7 |
| Example 9 | 0.5 | 8 | 46 | 46 | — | 0.03 |
| Comparative | 600 | — | — | — | — | — |
| Example 1 | | | | | | |
| Comparative | 550 | — | — | — | — | — |
| Example 2 | | | | | | |
| Comparative | 0.5 | 3 | — | 97 | — | 1 |
| Example 3 | | | | | | |
| Comparative | — | — | — | — | — | — |
| Example 4 | | | | | | |
| Comparative | 0.5 | 50 | — | 50 | — | — |
| Example 5 | | | | | | |

As shown in the tables, in the separating methods and the separating devices of Examples 1 to 9, each liquid mixture of the hydrocarbon liquid and the alcohol liquid could be separated without any corrosion problem due to the alcohols. On the other hand, in the separating methods and the separating devices of Comparative Examples 1 to 5, these mixtures could not be separated, or the corrosion problem occurred.

### INDUSTRIAL APPLICABILITY

A method for separating a liquid mixture and a device for separating a liquid mixture of the present invention can be used in the separation of the liquid mixture containing a hydrocarbon liquid and an alcohol liquid.

### DESCRIPTION OF REFERENCE MARKS

1: porous base material, 1a: monolith shape base material, 2; through hole (through linear hole), 3: side surface, 4: end surface, 5: inner wall surface, 11: separation membrane, 11a: membrane supply side, 11b: membrane permeation side, 12: seal portions, 31: raw material side space, 32: permeation side space, 33: o-ring, 35: raw material tank, 36: circulating pump, 37: module, 37a: supply liquid introduction port, 37b: supply liquid discharge port, 37c: permeation vapor recovery port, 38: cooling trap, 39: vacuum pump, 40: supply liquid heating unit, 41: pressure raising unit, 51: opening, 60: longitudinal direction, 100: separation membrane member, and 101: mixture separating device.

1. A method for separating a liquid mixture, in which the liquid mixture containing a hydrocarbon liquid and an alcohol liquid is used as a supply mixture liquid, and at least part of the supply mixture liquid is, in a liquid state, brought into contact with a membrane supply side of a separation membrane, and discharged in a vapor state through a membrane permeation side of the separation membrane, whereby a composition of a mixture vapor which is balanced with the supply mixture liquid becomes different from a composition of a vapor on the membrane permeation side.

2. The method for separating the liquid mixture according to claim 1,
wherein a weight fraction of alcohols in the mixture vapor discharged in the vapor state on the membrane permeation side is larger than a weight fraction of alcohols in the mixture vapor which is balanced with the supply mixture liquid.

3. The method for separating the liquid mixture according to claim 1,
wherein an absolute pressure on the membrane permeation side is 450 torr or lower.

4. The method for separating the liquid mixture according to claim 1,
wherein the supply mixture liquid is controlled at 50° C. or higher and at a temperature lower than a temperature at which all the supply mixture liquid evaporates.

5. The method for separating the liquid mixture according to claim 1,
wherein a pressure of the supply mixture liquid is raised by pressurizing, to increase a membrane permeation amount.

6. The method for separating the liquid mixture according to claim 5,
wherein a pressure for the pressurizing is controlled to an absolute pressure of 1 atm or higher and 100 atm or lower.

7. A device for separating a liquid mixture, which separates the liquid mixture containing a hydrocarbon liquid and an alcohol liquid, comprising:
a separating section provided with a separation membrane which allows permeation of the liquid mixture containing the hydrocarbon liquid and the alcohol liquid, so that a composition of the liquid mixture is changeable, and including a porous base material which supports this separation membrane, to partition a raw material side space and a permeation side space by the porous base material;
a supply section which supplies the liquid mixture to the raw material side space; and
a permeation recovering section to recover, from the permeation side space, a permeation gas which has permeated the separation membrane for the liquid mixture.

8. The device for separating the liquid mixture according to claim 7,
wherein the permeation recovering section includes a cooling unit which cools and liquefies the permeation gas.

9. The device for separating the liquid mixture according to claim 7, further comprising:
a supply liquid heating unit which heats the liquid mixture as the supply mixture liquid to be supplied to the separating section.

10. The device for separating the liquid mixture according to claim 7, further comprising:
a pressure raising unit which raises a pressure of the liquid mixture as the supply mixture liquid to be supplied to the separating section.
